(19) United States
(12) Patent Application Publication
(10) Pub. No.: US 2002/0053368 A1
(43) Pub. Date: May 9, 2002

(54) Apparatus and method for filling a tank for an ignitable medium

(76) Inventors: Janusz Blaszczyk, Richmond (CA); Alan Mulvenna, North Vancouver (CA)

Correspondence Address: CROWELL & MORING, L.L.P., P.O. Box 14300, Washington, DC, 20044-4300, US

(21) Appl. No.: 09/986,129

(22) Filed: Nov. 7, 2001

(30) Foreign Application Priority Data
Nov. 7, 2000 (DE) 100 55 104.1

(51) Int. Cl. B65B 3/00; B67C 3/00; B65B 1/04

(52) U.S. Cl. 141/348

(57) ABSTRACT

A device is provided for filling a tank with a combustible medium from storage container. Supply means are disposed on the side of the storage container and receiving means are disposed on the side of the tank for introducing the medium into the tank. The supply means and the receiving means include closing means. The device further includes potential equalization means for equalizing an electrical potential between the storage container and the tank. The potential equalization means are arranged on the supply means or on the receiving means so that when the supply means move towards the receiving means, the potential equalization means can be forced into electrical contact with the housing of the tank. When the supply means subsequently come even closer to the chassis, the potential equalization means unlocks the closing means disposed on the supply means and/or the receiving means.

### BACKGROUND AND SUMMARY OF THE INVENTION

This application claims the priority of 100 55 104.1, filed Nov. 7, 2000, the disclosure of which is expressly incorporated by reference herein.

The invention relates to a device and method for filling a tank with a combustible medium. Preferred embodiments of the invention relate to a device for filling a tank with a combustible medium from a storage container, with a supply means disposed on the side of the storage container and a receiving means disposed on the side of the tank for introducing the medium into the tank, wherein the supply means and the receiving means comprise closing means, and with a potential equalization means for equalizing an electrical potential between the storage container and the tank.

German Patent Document DE 41 04 766 A1 describes a filling system for a motor vehicle that operates using cryogenic hydrogen. Conventional systems for filling hydrogen tanks in vehicles require various manual operations to equalize the electrical potential between the filling station and the motor vehicle in order to prevent dangerous sparking while filling the vehicle tank. Before the filling operation begins, a grounding cable is attached to the vehicle chassis, whereafter the tank of the vehicle is filled. This process is time-consuming, so that it takes a long time to fill many vehicles, for example, at the filling station.

It is a therefore an object of the invention to provide a device and method that allows filling of a tank from a storage container in a simple and safe manner.

This object is achieved according to certain preferred embodiments of the invention by a device for filling a tank with a combustible medium from a storage container, with a supply means disposed on the side of the storage container and a receiving means disposed on the side of the tank for introducing the medium into the tank, wherein the supply means and the receiving means comprise closing means, and with a potential equalization means for equalizing an electrical potential between the storage container and the tank, characterized in that the potential equalization means is arranged on the supply means or on the receiving means so that when the supply means moves close to the receiving means, the potential equalization means can be brought forcibly into electrical contact with a housing of the tank, and that during a subsequent further approach the closing means disposed on the supply means and/or the receiving means is released by the potential equalization means.

In a device according to the invention, a potential equalization means for equalizing an electrical potential between a storage container and a tank is disposed on a supply means and/or a receiving means, wherein the potential equalization means is arranged on the supply means or on the receiving means in such a way that first the potential equalization means can be forcibly brought into electrical contact with a housing of the tank when the supply means is moved towards the receiving means. During a following closer approach, the closing means located on the supply means and/or receiving means is then released by the potential equalization means.

With this arrangement, the potential is advantageously always equalized before the tank is filled. In other words, it is impossible to inadvertently omit this step, so that dangerous sparking can advantageously be eliminated.

Further advantages and embodiments of the invention are described below and in the claims.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram of a preferred embodiment of a device for filling a tank with a combustible medium from a storage tank,

FIG. 2 is a device representing the present state-of-the-art; and

FIG. 3 is a partial view of a potential equalization device usable in the FIG. 1 arrangement.

### DETAILED DESCRIPTION OF THE DRAWINGS

The device according to the invention is particularly suited for filling tanks of motor vehicles with hydrogen. However, the device can also be used with systems that operate with a different combustible medium, for example gases or liquids, such as gasoline or methanol.

FIG. 2 illustrates a conventional arrangement for filling a tank of a motor vehicle with hydrogen. A tank opening 2 is provided in a vehicle chassis 1. The tank opening 2 includes sealing means 3, 4. A filling tube 7 is inserted into the tank opening 2, and pressed by locking means 5,6 against the sealing means 3, 4 located on the side of the chassis, where it is sealed. The tube 7 projects into the tank opening and is in addition sealed on the projecting end by additional sealing means 8. The tube 7 can be surrounded, for example, by an isolation vacuum when the hydrogen is transferred from a storage container into the tank of the motor vehicle.

However, the chassis has to be grounded separately in the arrangement of FIG. 2.

With the system according to the invention, unlike with conventional systems, a filling device can be handled easily and reliably and grounded on the chassis, so that the tank can be filled in a single operation. It is particularly advantageous that the tank can only be filled after the potential is equalized between the device to be filled and the storage tank.

The invention will now be described with reference to a vehicle to be filled with hydrogen, preferably a vehicle incorporating a fuel cell system. The device according to the invention, however, is also suited for use with other media, which have to be handled so as to eliminate sparking due to an electric discharge. Likewise, application of the invention is not limited to fuel tanks of motor vehicles. Other preferred embodiments of the invention can advantageously being employed wherever a medium has to be transferred between containers that are to be protected from electric discharge.

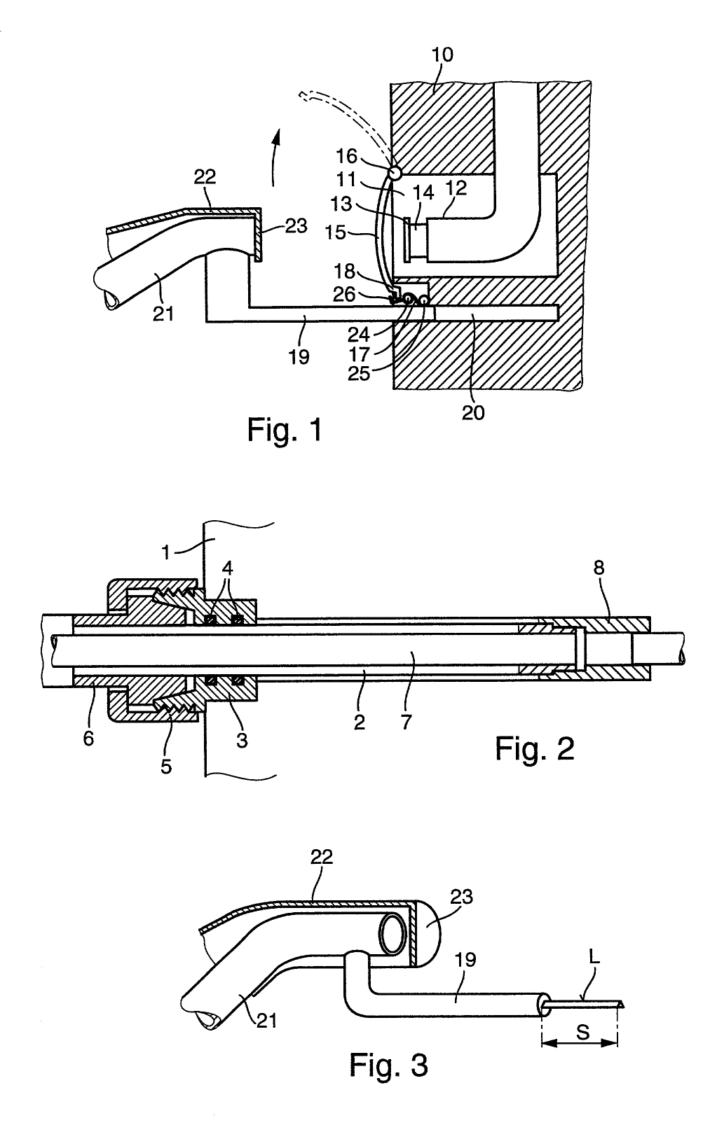

FIG. 1 shows a preferred embodiment of a filling tank of a motor vehicle for use with hydrogen gas or liquid hydrogen. A housing of a vehicle chassis 10, respectively, includes a tank opening 11 formed as an opening in the housing of the chassis 10. A pipe socket 12 projects into the tank opening 11, with the pipe socket 12 terminating in a schematically depicted tank located in the vehicle and functioning as a receiving means 12. The entrance region of the pipe socket 12 includes a section 14 which has a smaller outside diameter than the end section 13.

The tank opening 11 is closed with a sealing cap 15 that can be rotated about an articulated joint 16 for uncovering the tank opening and the pipe socket 12. The sealing cap 15 can simultaneously serve as a closing means for the tank opening 11 and the pipe socket 12. When closed, the sealing cap 15 is locked by a locking mechanism 17. For this purpose, the sealing cap has a shoulder 18 adapted to lockingly engage with the locking mechanism 17.

The locking mechanism 17 releases the sealing cap 15 only after an electrical potential equalization connection is established between the chassis 10 and a fuel delivery nozzle 21 and/or a storage container to which the fuel delivery nozzle is connected. The sealing cap 15 can be rotated by hand or with the help of a pivot mechanism (not shown) about the pivot point 16.

In addition, the chassis 10 includes an opening 20 adapted to receive a pin 19 which enables electrical potential equalization between the chassis 10 and a fuel delivery nozzle 21. The pin 19 provides an electrically conducting, preferably metallic, connection between the chassis 10 and the fuel delivery nozzle 21. The fuel delivery nozzle 21 and the pipe socket 12 are preferably connected via a bayonet-type coupling to transfer the medium from the storage container through the fuel delivery nozzle 21 and the pipe socket 12 into the tank.

When the pin 19 is pushed into the opening 20, the pin releases the locking mechanism 17 upon engagement with the opening 20 to release the sealing cap 15. The locking mechanism 17 can rotate about an articulated joint 24. If a pin 19 has not been pushed into the opening 20, then the locking mechanism 17 can lock the sealing cap 15 with the help of a hook 26 disposed on one end of the locking mechanism 17. A counterweight 25 is located on the opposite end of the locking mechanism 17, wherein the counterweight 25 urges the hook 26 against the sealing cap 15 when the opening 20 is unoccupied. Advantageously, the hook 26 can additionally be supported by a spring force when lockingly engaging with the sealing cap 15 according to certain preferred embodiments. This can be achieved by suitably providing a spring on the articulated joint 24.

When the pin 19 is pushed into the opening, the counterweight 25 is moved in a direction to drive the hook 26 of the locking mechanism 17 away from the sealing cap 15.

The rod 19 is preferably rigidly connected with the fuel delivery nozzle 21. The fuel delivery nozzle 21 can have a hinged cover 22 with a lid 23 that closes the fuel delivery nozzle 21 if no filling operation takes place.

In particularly advantageous embodiments, the sealing cap can reliably be unlocked mechanically.

If hydrogen is to be transferred from a storage container into the tank of the vehicle, then the fuel delivery nozzle is manually or automatically moved towards the tank opening 11. During this operation, the rod 19 is inserted into the opening 20, thereby connecting the different potentials. Accordingly, sparking caused by electrostatic discharge is eliminated. At the same time, the hinged cover 22 on the fuel delivery nozzle 21 can be opened, either manually, for example with the thumb, or automatically during insertion of rod 19. The lid 23 rotates out of the way and uncovers the orifice of the fuel delivery nozzle 21. When the rod 19 is inserted deeper, i.e., when the fuel delivery nozzle 21 moves closer to the tank opening, the locking mechanism 17 is released, allowing the sealing cap to be rotated out of the way to uncover the tank opening 11. The fuel delivery nozzle 21 can then be inserted into the tank opening 11 and pushed over the pipe socket 12. The opening 11 receives the fuel delivery nozzle 21 and the hinged cover 22 that was rotated out of the way.

Contact between the fuel delivery nozzle 21 and the pipe stump or socket 12 can be established with conventional locking means and/or sealing means. Advantageously, the fuel delivery nozzle 21 and the pipe socket 12 can be connected with a bayonet-type coupling according to certain preferred embodiments.

Alternatively, the fuel delivery nozzle 21 can be designed for insertion into the pipe socket 12. With this advantageous embodiment, a potential equalization connection is always established automatically before the filling operation can begin. Establishing the connection does not require complex manipulation and can be performed manually, using only one hand, at the same time the fuel delivery nozzle 21 is inserted into the chassis 10. Insertion of the rod 19 into the opening 20 can also protect the connection from contamination.

The potential equalization connection 19 can also be implemented by using a spring element instead of a rod according to other contemplated embodiments. The spring element is hereby connected with the fuel delivery nozzle 21 and contacts the chassis when the fuel delivery nozzle 21 is moved towards the chassis 10, thereby establishing the electric connection for equalizing the potential. The spring force hereby couples the fuel delivery nozzle 21 with the pipe socket 12, providing a particularly close and reliable electrical connection.

The pin can in addition include a tip L with a length that corresponds approximately to the distance s required to release the sealing cap 15, as shown in FIG. 3. The pin can be pushed deeper into the opening only after the sealing cap 15 is open, thereby preventing the sealing cap 15 and the flap 22 and the lid 23 from colliding with each other.

In another preferred embodiment, a potential equalization connection can also be established by inserting a contact rod with a formed tip into an opening in the chassis 20. The particular shape of the tip allows the contact rod to be inserted in only one position. There is no direct mechanical connection between the sealing cap 15 and the contact rod. When the sealing cap 15 is open, the contact rod is rotated and moved forward so that the fuel delivery nozzle 21 can move close to the pipe socket 12 for performing the filling operation.

The spring or rod for potential equalization can also be arranged on the tank. The device according to the invention can also be used to fill stationery facilities.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. Device for filling a tank with a combustible medium from a storage container, with a supply means disposed on the side of the storage container and a receiving means disposed on the side of the tank for introducing the medium into the tank, wherein the supply means and the receiving means comprise closing means, an electrical potential equalization means being provided for equalizing an electrical potential between the storage container and the tank,
wherein the potential equalization means is arranged on one of the supply means and the receiving means so that when the supply means moves close to the receiving means, the potential equalization means is brought forcibly into electrical contact with a housing of the tank, and
wherein during a subsequent further approach, closing means disposed on one of the supply means and the receiving means is released by the potential equalization means.

2. Device according to claim 1, wherein the receiving means is a disposed in an opening of a housing of the tank.

3. Device according to claim 2, wherein the at least one of the receiving means and the opening can be closed by a closing means that can be locked by a locking mechanism.

4. Device according to claim 3, wherein the locking mechanism is in a locking position when the supply means is distal and is in a release position when the supply means is proximate a fueling position.

5. Device according to claim 1, wherein an opening is provided in the housing of the tank, in which opening the potential equalization means can be inserted.

6. Device according to claim 5, wherein the potential equalization means is in the shape of a rod.

7. Device according to claim 4, wherein one end of the locking mechanism projects at least partially into the opening, so that the locking mechanism can be rotated about an axis by the potential equalization means when the potential equalization means is inserted.

8. Device according to claim 5, wherein one end of the locking mechanism projects at least partially into the opening, so that the locking mechanism can be rotated about an axis by the potential equalization means when the potential equalization means is inserted.

9. Device according to claim 6, wherein one end of the locking mechanism projects at least partially into the opening, so that the locking mechanism can be rotated about an axis by the potential equalization means when the potential equalization means is inserted.

10. Device according to claim 1, wherein the potential equalization means is a spring that can be brought into contact with the housing by applying a pressure.

11. An assembly comprising:
a fuel supply nozzle having a fuel outlet opening engageable with a fuel inlet opening at a housing of a tank when in a fueling position for transferring fuel to said tank through said fuel outlet opening and said fuel inlet opening during a fueling operation, and
an electrically conducting member connected with the fuel supply nozzle and engageable with said housing to equalize an electrical potential of said fuel supply nozzle and said housing when said fuel outlet opening is in the fueling position, wherein said electrically conducting member is configured to contact said housing during movement of the fuel supply nozzle toward said fueling position and before the fuel supply nozzle reaches said fueling position, thereby assuring equalization of the electrical potential of the fuel nozzle and the housing during said fueling operation.

12. An assembly according to claim 11, wherein said electrically conducting member is a rod rigidly connected with the fuel supply nozzle and spaced from the fuel outlet opening.

13. An assembly according to claim 11, wherein said electrically conducting member is a spring member.

14. An assembly according to claim 11, comprising a fuel outlet cover member movable between a fuel outlet closed and open position, and wherein means are provided for maintaining said fuel outlet cover member in said fuel outlet closed position whenever said fuel nozzel is in a non-fueling position with said electrically conducting member other than in a position electrically connecting the housing and fuel supply nozzle.

15. An assembly according to claim 11, wherein said electrically conducting member is configured to sequentially contact said housing and open a fuel inlet cover covering the fuel inlet opening during movement of the fuel supply nozzle to said fueling position.

16. A vehicle fueling system for transferring hydrogen fuel to a vehicle tank having a vehicle tank support housing, comprising:
a first housing opening in said vehicle tank support housing,
an inlet pipe disposed in said first housing and leading to the vehicle tank,
a housing cover member movable between a closed vehicle operating position covering the first housing opening and inlet pipe and an open fueling position,
a fuel supply nozzle connected with a fuel storage tank and movable into a fueling position opening into the inlet pipe when said housing cover member is in said open fueling position, and
an electrically conducting member rigidly connected with the fuel supply nozzle and configured to contact the housing during movement of the fuel supply nozzle toward said fueling position and before said fueling position is reached to thereby assure equalization of electrical potential between the housing and fuel supply nozzle before and after movement of the housing cover member to the open fueling position.

17. A vehicle fueling system, according to claim 16, wherein said electrically conducting member is a rod slidably engageable in a conducting member opening in said housing when said fuel nozzle is moved toward the first housing opening.

18. A vehicle fueling system according to claim 17, comprising a housing cover locking mechanism operable to lock the housing cover member in the closed position.

19. A vehicle fueling system according to claim 18, wherein said rod is configured to sequentially electrically contact the housing and open the housing cover locking mechanism during movement of the fuel supply nozzle toward the first housing opening while continuously maintaining electrical contact of the fuel supply nozzle and housing.

20. A vehicle fueling system according to claim 19, wherein said fuel supply nozzle is configured to be manually movable to said fueling position by a one hand operation with said rod first being inserted into the conducting member opening, followed by further movement into the conducting member opening to open the housing cover locking mechanism, and followed by further movement to said fueling position.

21. A method of fueling a hydrogen fueled vehicle using the fueling system of claim 16.

22. A method of fueling a hydrogen fueled vehicle using the fueling system of claim 20.
